(19) United States
(12) Patent Application Publication
(10) Pub. No.: US 2025/0265108 A1
(43) Pub. Date: Aug. 21, 2025

(54) COMMUNICATION DEVICE AND COMMUNICATION METHOD

(71) Applicant: Renesas Electronics Corporation, Tokyo (JP)

(72) Inventor: Takuro NISHIKAWA, Tokyo (JP)

(21) Appl. No.: 18/967,957

(22) Filed: Dec. 4, 2024

(30) Foreign Application Priority Data
Feb. 21, 2024 (JP) 2024-024420

(51) Int. Cl. G06F 9/455

(52) U.S. Cl. CPC G06F 9/45558; G06F 2009/45587

(57) ABSTRACT

A communication device includes a communication control unit. The communication control unit includes a plurality of protocol processing units and a plurality of received data storage areas. A received message that is a CAN message received by the communication device is input into the plurality of protocol processing units. In a case where the destination of the received message is a virtual machine corresponding to the protocol processing unit itself, each protocol processing unit stores the payload of the received message in the received data storage area accessible from the destination virtual machine.

### CROSS-REFERENCE TO RELATED APPLICATIONS

The disclosure of Japanese Patent Application No. 2024-024420 filed on Feb. 21, 2024 including the specification, drawings and abstract is incorporated herein by reference in its entirety.

### BACKGROUND

The present disclosure relates to a technology for performing communication in accordance with a controller area network (CAN) protocol.

There are disclosed techniques listed below.
[Patent Document 1] Japanese Unexamined Patent Application Publication No. 2022-123826

A system that performs communication in accordance with a CAN protocol (hereinbelow, CAN communication) has been developed. For example, Patent Document 1 discloses a technology for a CAN controller to transfer a CAN message to a virtual machine in a microcontroller in which a plurality of virtual machines operate.

### SUMMARY

The CAN controller in Patent Document 1 uses a direct memory access (DMA) controller to store the CAN message in a random access memory (RAM) of the virtual machine. Patent Document 1 does not disclose, as a method for enabling the virtual machine to use the CAN message, a method other than a method of storing the CAN message in the RAM of the virtual machine by using the DMA controller. Other objects and novel features will become apparent from the description of the present specification and the accompanying drawings.

A communication device according to an embodiment includes a plurality of protocol processing units and a plurality of received data storage areas. A CAN message received by the communication device is input into the plurality of protocol processing units. In a case where the destination of the CAN message is a virtual machine corresponding to the protocol processing unit itself, each protocol processing unit stores the payload of the CAN message in a received data storage area accessible from the destination virtual machine.

According to the present disclosure, there is provided a new technology for causing a virtual machine as a destination of a CAN message to use the CAN message received by a communication device in which a plurality of virtual machines operate.

### BRIEF DESCRIPTION OF THE DRAWINGS

FIG. 1 is a diagram illustrating a configuration of a communication device according to a first embodiment.

FIG. 2 is a block diagram illustrating a hardware configuration of a virtual machine execution unit.

FIG. 3 is a flowchart illustrating a procedure of message reception processing in the communication device.

FIG. 4 is a diagram illustrating a case where a CAN ID is allocated to each application.

FIG. 5 is a diagram illustrating a configuration related to transmission of a transmitted message in the configuration of the communication device.

FIG. 6 is a flowchart illustrating a procedure of message transmission in the communication device.

FIG. 7 is a diagram illustrating a configuration in which a status signal is output from a protocol processing unit.

FIG. 8 is a diagram illustrating a configuration in which an individual reception unit is provided for each protocol processing unit.

FIG. 9 is a diagram illustrating a configuration in which an individual transmission unit is provided for each protocol processing unit.

FIG. 10 is a diagram illustrating a hierarchical structure of a system having a zone ECU FIG. 11 is a diagram illustrating a configuration of a communication device according to a second embodiment.

FIG. 12 is a diagram illustrating a configuration of the communication device related to transmission of a transmitted message.

FIG. 13 is a flowchart illustrating a procedure of message reception in the communication device.

FIG. 14 is a flowchart illustrating a procedure of message transmission in the communication device.

### DETAILED DESCRIPTION

Hereinbelow, embodiments of the present disclosure will be described in detail with reference to the drawings. In the drawings, the same or corresponding elements are denoted by the same reference numerals, and redundant description is omitted as necessary for clarity of description. In addition, unless otherwise described, preset values such as predetermined values and threshold values are stored in advance in a storage device or the like accessible from a device using the values.

Furthermore, unless otherwise described, a storage unit includes as many storage devices as the freely-selected number that is one or more.

### First Embodiment

### Overview

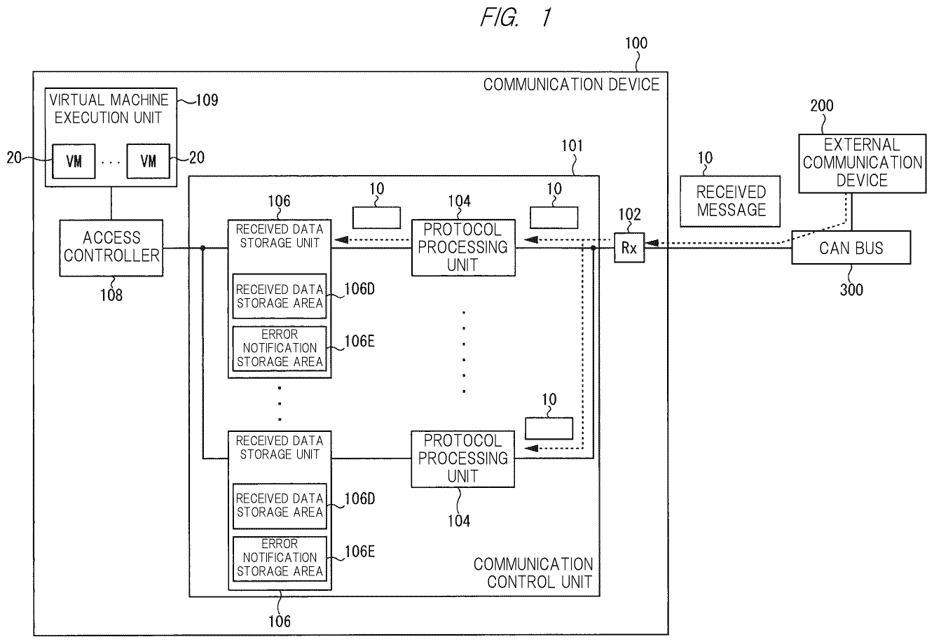

FIG. 1 is a diagram illustrating a configuration of a communication device 100 according to a first embodiment. The communication device 100 transmits and receives a CAN message to and from an external communication device 200 in accordance with a CAN protocol. The communication device 100 is connected to the external communication device 200 via a CAN bus 300. The CAN bus 300 is a communication path used for CAN communication between the communication device 100 and the external communication device 200, and is, for example, a bus.

For example, the communication device 100 is an integrated circuit provided inside an electronic control unit (ECU) or the like. A more specific example of the communication device 100 is a system on chip (SoC) such as a micro control unit (MCU). Similarly to the communication device 100, for example, the external communication device 200 is an integrated circuit provided inside an ECU or the like.

The communication device 100 includes a common reception unit 102, a communication control unit 101, an access controller 108, and a virtual machine execution unit 109. In the communication device 100, the common reception unit 102 is an interface into which the CAN message (hereinbelow, a received message 10) transmitted from the external communication device 200 is input. The common reception unit 102 is configured to output the input received message 10 to the communication control unit 101. More specifically, the common reception unit 102 is configured to receive a signal flowing through the CAN bus 300 and output the received signal to the communication control unit 101. Note that the common reception unit 102 and the CAN bus 300 are connected via a suitable interface such as a CAN transceiver as necessary.

The communication control unit 101 includes a plurality of protocol processing units 104 and a plurality of received data storage units 106. The received data storage unit 106 is a storage area provided in a freely-selected type of storage device (for example, a RAM, a register, or the like). For example, the plurality of received data storage units 106 include different partial storage areas included in one storage device (for example, one RAM or register), respectively. Alternatively, for example, the plurality of received data storage units 106 may be storage areas included in different storage devices (for example, different RAMs and registers), respectively.

Also, each of the plurality of received data storage units 106 includes a received data storage area 106D and an error notification storage area 106E. The received data storage area 106D stores received data included in the received message 10.

The error notification storage area 106E stores an error notification related to communication.

The received data storage area 106D and the error notification storage area 106E included in each received data storage unit 106 may be different partial storage areas of one storage device (for example, one RAM or register), respectively. Alternatively, for example, the received data storage area 106D and the error notification storage area 106E may include different storage devices, respectively. In this case, for example, the received data storage area 106D includes a partial storage area included in one storage device (for example, one RAM or register). On the other hand, the error notification storage area 106E includes a different storage device (for example, one RAM or register) from the storage device including the received data storage area 106D.

The virtual machine execution unit 109 operates a plurality of virtual machines (VMs) 20. For example, the virtual machine execution unit 109 operates a hypervisor for managing the virtual machines. The plurality of virtual machines 20 operates under the management by the hypervisor. Note that the plurality of virtual machines 20 may include a virtual machine for management.

The plurality of virtual machines 20 are configured to be able to access different received data storage units 106, respectively. Hereinbelow, the received data storage unit 106 accessible by the virtual machine 20 is also referred to as a “received data storage unit 106 corresponding to the virtual machine 20”.

The access controller 108 controls access from the virtual machine 20 to the received data storage unit 106. Specifically, in a case where the received data storage unit 106 to be accessed by the virtual machine 20 is the received data storage unit 106 corresponding to the virtual machine 20, the access controller 108 permits the virtual machine 20 to access the received data storage unit 106. On the other hand, in a case where the received data storage unit 106 to be accessed by the virtual machine 20 is not the received data storage unit 106 corresponding to the virtual machine 20, the access controller 108 does not permit the virtual machine 20 to access the received data storage unit 106. Note that the correspondence relationship between the virtual machines 20 and the received data storage units 106 is stored in advance in a freely-selected storage area accessible from the access controller 108, for example.

The protocol processing unit 104 performs processing on the received message 10 so that the virtual machine 20 that is the destination of the received message 10 can use a payload of the received message 10. The protocol processing unit 104 is also referred to as a CAN protocol engine or the like. The plurality of protocol processing units 104 are associated with different virtual machines 20, respectively.

Specifically, the protocol processing unit 104 extracts the payload and a CAN identifier (CAN ID) from the received message 10 in accordance with the CAN protocol. Whether to store the extracted payload in the received data storage area 106D is determined by a reception filter, which is not illustrated in FIG. 1. In other words, it is determined whether the received message 10 is a message to be used in the corresponding virtual machine 20. The extracted payload is stored in the received data storage area 106D corresponding to the virtual machine 20 based on the determination result.

On the other hand, in a case where the received message 10 is not one for use in the corresponding virtual machine 20, the payload of the received message 10 is not stored in the received data storage area 106D.

As a result of processing by the reception filter, which is not illustrated in FIG. 1, the payload of the received message 10 is stored in one received data storage area 106D. The received data storage area 106D in which the payload of the received message 10 is stored is included in the received data storage unit 106 accessible from the virtual machine 20 that is to use the received message 10. Therefore, the payload of the received message 10 is stored in the received data storage unit 106 so as to be accessible only from the virtual machine 20 that is to use the received message 10.

Here, the virtual machine 20 recognizes that data is stored in the received data storage area 106D corresponding to the virtual machine itself by an appropriate method. For example, the virtual machine 20 recognizes that new data is stored in the received data storage area 106D by periodically checking the content of the received data storage area 106D corresponding to the virtual machine itself. Alternatively, for example, in response to data being stored in the received data storage area 106D, a specific notification may be transmitted to the virtual machine 20 corresponding to the received data storage area 106D. In this case, the virtual machine 20 recognizes that new data is stored in the received data storage area 106D corresponding to the virtual machine itself by receiving the specific notification.

Note that, in the received data storage area 106D, not only the payload extracted from the received message 10 but also the CAN ID may be stored by the protocol processing unit 104, for example.

### Example of Operation and Effect

According to the present disclosure, there is provided a new technology for enabling a virtual machine as a destination of a CAN message to use a payload of the CAN message in the communication device 100 that receives the CAN message. Specifically, in the communication device 100, the received message 10 is input into the plurality of protocol processing units 104. Further, only the protocol processing unit 104 corresponding to the virtual machine 20 as a destination of the received message 10 stores the payload of the received message 10 in the received data storage unit 106 corresponding to the virtual machine 20. Access to the received data storage unit 106 by each virtual machine 20 is controlled by the access controller 108.

In this manner, according to the communication device 100, one protocol processing unit 104 and one received data storage unit 106 are associated with one virtual machine 20. Such a correspondence relationship between one protocol processing unit 104 and one virtual machine 20 is the same as the correspondence relationship between one protocol processing unit 104 and one physical machine (one OS) in a case where the virtualization environment is not used. Therefore, software usability is higher than in a case where a plurality of virtual machines 20 are handled by one protocol processing unit 104 and one received data storage unit 106.

For example, in a case where the plurality of virtual machines 20 share one protocol processing unit 104 and one received data storage unit 106, data used by the plurality of virtual machines 20 is stored in one received data storage unit 106. The fact that data is newly stored in the received data storage unit 106 is recognized only by the virtual machine 20 operating at that time.

For example, it is assumed that the first virtual machine 20 recognizes that new data is stored in the received data storage unit 106. At this time, the data stored in the received data storage unit 106 is not necessarily data to be used in the first virtual machine. The first virtual machine 20 needs to confirm whether or not the data stored in the received data storage unit 106 is data to be used by the first virtual machine 20. In a case where the data stored in the received data storage unit 106 is not for use in the first virtual machine 20 operating at that time, the first virtual machine 20 may need to notify the second virtual machine 20 that the data to be used in the second virtual machine 20 has been stored in the received data storage unit 106. In a case where the plurality of virtual machines 20 share one protocol processing unit 104 and one received data storage unit 106, it is necessary to prepare software assuming such a situation for each virtual machine 20.

On the other hand, according to the communication device 100, as described above, one protocol processing unit 104 and one received data storage unit 106 are allocated to each virtual machine 20. Therefore, the fact that the data is stored in the received data storage unit 106 allocated to the first virtual machine 20 is easily recognized by the first virtual machine 20 that is to use the data. That is, the first virtual machine 20 only needs to grasp the data storage state in the received data storage unit 106 allocated thereto, and does not need to notify the other virtual machines 20 of the data storage state. Therefore, it is possible to heighten software usability related to communication processing of the virtual machine 20.

Hereinbelow, the communication device 100 of the present embodiment will be described in more detail.

### Example of Hardware Configuration of Communication Device 100

The communication device 100 is achieved by, for example, an integrated circuit such as an MCU as described above. The communication device 100 may be achieved by an integrated circuit provided on one substrate, or may be achieved by connecting integrated circuits correspondingly provided on a plurality of substrates to each other. The communication device 100 may be achieved by a dedicated integrated circuit designed to achieve the communication device 100, or may be achieved by a general-purpose integrated circuit.

### Example of Hardware Configuration of Virtual Machine Execution Unit 109

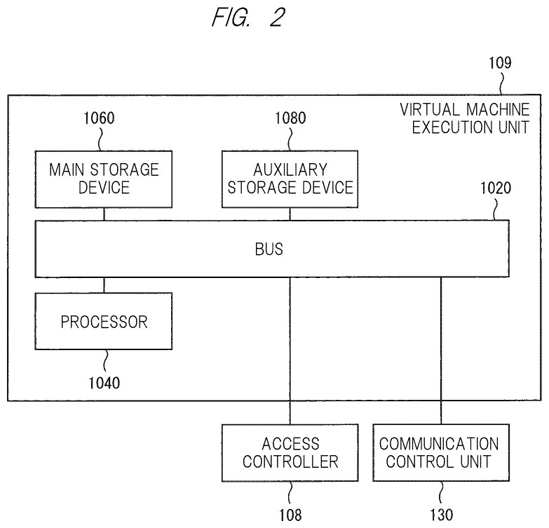

FIG. 2 is a block diagram illustrating a hardware configuration of the virtual machine execution unit 109. In the configuration in FIG. 2, the virtual machine execution unit 109 includes a bus 1020, a processor 1040, a main storage device 1060, and an auxiliary storage device 1080.

The bus 1020 is a communication path for the processor 1040, the main storage device 1060, and the auxiliary storage device 1080 to transmit and receive data to and from each other. The processor 1040 is a freely-selected type of processor such as a central processing unit (CPU) and a field-programmable gate array (FPGA). The main storage device 1060 is a main storage device achieved by using a RAM or the like. The auxiliary storage device 1080 is an auxiliary storage device achieved by using a flash memory or the like.

The auxiliary storage device 1080 stores programs for achieving the virtual machine execution unit 109. The programs for achieving the virtual machine execution unit 109 include, for example, a program for achieving a hypervisor, programs executed on each virtual machine 20, and the like. The programs executed on the virtual machine 20 includes, for example, an operating system (OS) that operates on the virtual machine 20, an application program that operates on the OS, and the like. The processor 1040 reads these various programs into the main storage device 1060 and executes the programs to operate the hypervisor and each virtual machine 20.

The virtual machine execution unit 109 is connected to the access controller 108 via the bus 1020.

Communication performed by the virtual machine execution unit 109 is not limited to CAN communication. In a case where the virtual machine execution unit 109 performs communication other than CAN communication, the virtual machine execution unit 109 is connected to a control unit that controls the communication via the bus 1020. In FIG. 2, the virtual machine execution unit 109 is connected to a communication control unit 130. The communication control unit 130 is, for example, a control unit for Ethernet (registered trademark) communication.

Note that, in the virtualization environment, the plurality of virtual machines may share one physical hardware element (processor or storage device). Therefore, in the virtual machine execution unit 109, one physical hardware element may be shared by the plurality of virtual machines 20. For example, the plurality of virtual machines 20 may share one processor provided in the virtual machine execution unit 109.

However, the virtual machine execution unit 109 may include the same type of physical hardware element for each virtual machine 20. In this case, for example, the plurality of virtual machines 20 may use different processors, respectively.

### <Procedure of Processing>

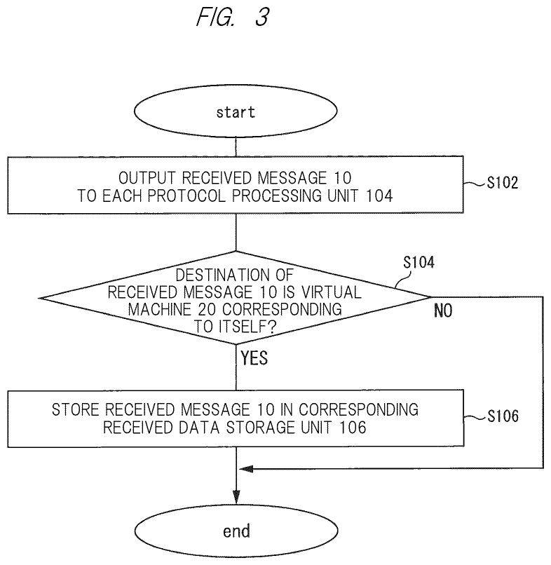

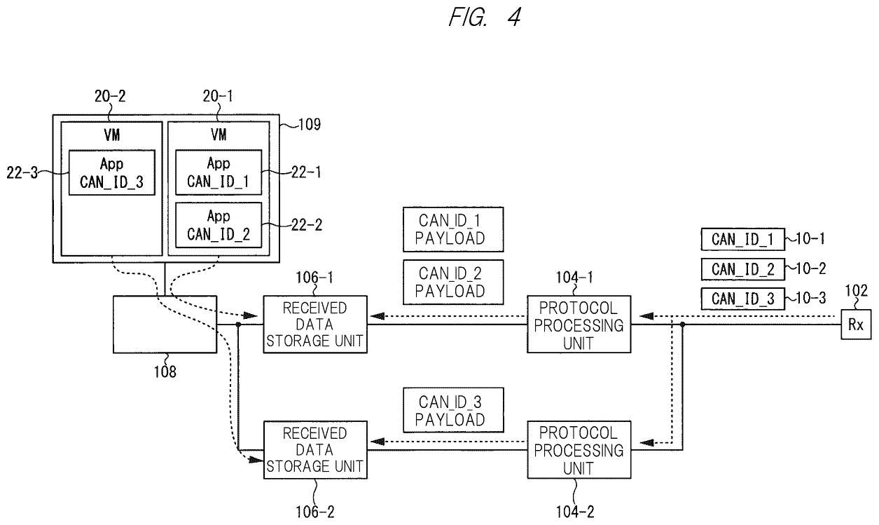

FIG. 3 is a flowchart illustrating a procedure of message reception processing in the communication device 100. The common reception unit 102 outputs the received message 10 to each of the plurality of protocol processing units 104 (S102).

S104 and S106 are executed by the plurality of protocol processing units 104. The protocol processing unit 104 determines whether or not the destination of the received message 10 input from the common reception unit 102 is the virtual machine 20 corresponding to the protocol processing unit itself (S104). In a case where the destination of the received message 10 is the virtual machine 20 corresponding to the protocol processing unit itself (S104: YES), the protocol processing unit 104 stores the payload of the received message 10 in the received data storage unit 106 corresponding to the protocol processing unit itself (S106). On the other hand, in a case where the destination of the received message 10 is not the virtual machine 20 corresponding to the protocol processing unit itself (S104: NO), the processing of storing the payload of the received message 10 in the received data storage unit 106 is not performed.

### <Specification of Destination of Received Message 10>

The protocol processing unit 104 determines whether or not the destination of the received message 10 is the virtual machine 20 corresponding to the protocol processing unit itself (S104). For this purpose, the protocol processing unit 104 specifies the destination of the received message 10.

The destination of the received message 10 is represented using, for example, the CAN ID indicated in the header of the received message 10. In this case, the correspondence relationship between the protocol processing units 104 and the virtual machines 20 is represented by the correspondence relationship between the protocol processing units 104 and the CAN IDs. In addition, the correspondence relationship between the received data storage units 106 and the virtual machines 20 is also represented by the correspondence relationship between the received data storage units 106 and the CAN IDs.

Therefore, for example, information indicating the CAN IDs corresponding to each protocol processing unit 104 and the received data storage units 106 corresponding to the CAN IDs is stored in storage area accessible from each protocol processing unit 104. Each protocol processing unit 104 can specify the CAN ID corresponding to the protocol processing unit itself by referring to this information. Further, each protocol processing unit 104 can specify the received data storage unit 106 in which the payload of the received message 10 is to be stored by referring to this information.

The protocol processing unit 104 determines whether or not the CAN ID indicated in the header of the received message 10 is the CAN ID corresponding to the protocol processing unit itself. In a case where the CAN ID indicated in the header of the received message 10 is the CAN ID corresponding to the protocol processing unit itself, the protocol processing unit 104 stores the received message 10 in the received data storage unit 106 corresponding to the CAN ID. On the other hand, in a case where the CAN ID indicated in the header of the received message 10 is not the CAN ID corresponding to the protocol processing unit itself, the protocol processing unit 104 does not store the received message 10 in any received data storage unit 106.

The CAN ID is allocated to the virtual machine 20, for example. In this case, in order to represent the correspondence relationship between the protocol processing unit 104 and the virtual machine 20, the protocol processing unit 104 and the CAN ID allocated to the virtual machine 20 corresponding to the protocol processing unit 104 are associated with each other.

Alternatively, for example, the CAN ID is allocated to an application that operates on the virtual machine 20. In this case, in order to represent the correspondence relationship between the protocol processing unit 104 and the virtual machine 20, the protocol processing unit 104 and the CAN ID allocated to the application that operates on the virtual machine 20 corresponding to the protocol processing unit 104 are associated with each other. In a case where a plurality of applications operate on the virtual machine 20, a plurality of CAN IDs can be associated with one protocol processing unit 104.

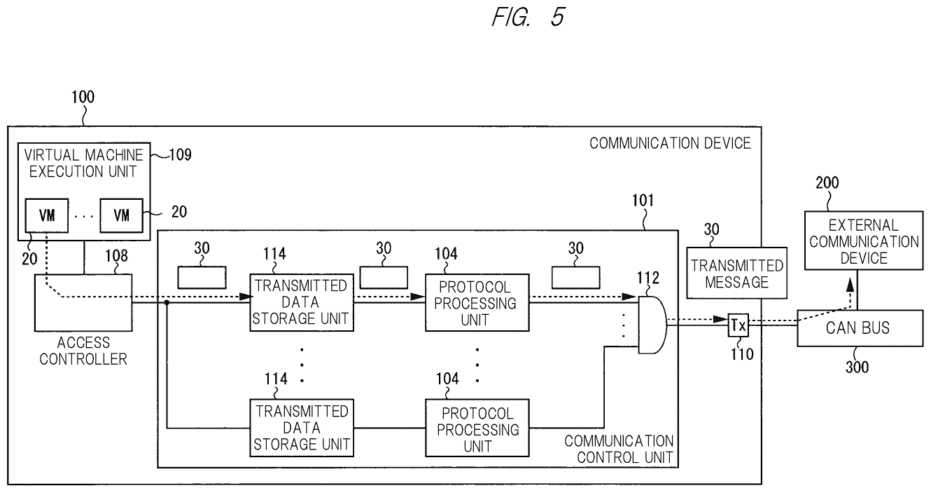

FIG. 4 is a diagram illustrating a case where a CAN ID is allocated to each application. In the example in FIG. 4, the communication device 100 includes two protocol processing units 104 (a protocol processing unit 104-1 and a protocol processing unit 104-2). Furthermore, the communication device 100 includes two received data storage units 106 (a received data storage unit 106-1 and a received data storage unit 106-2). In the virtual machine execution unit 109, two virtual machines 20 (a virtual machine 20-1 and a virtual machine 20-2) are operating.

On the virtual machine 20-1, two applications 22 (an application 22-1 and an application 22-2) are operating. The CAN ID allocated to the application 22-1 is CAN_ID_1, and the CAN ID allocated to the application 22-2 is CAN_ID_2.

The virtual machine 20-1 is associated with the protocol processing unit 104-1 and the received data storage unit 106-1. Therefore, both the protocol processing unit 104-1 and the received data storage 106-1 are associated with two CAN IDs, CAN_ID_1 and CAN_ID_2. In addition, the access controller 108 is set to permit the virtual machine 20-1 to access the received data storage unit 106-1.

On the virtual machine 20-2, one application 22-3 is operating. The CAN ID allocated to the application 22-3 is CAN_ID_3. Therefore, the CAN ID associated with the protocol processing unit 104-2 is CAN ID 3.

The virtual machine 20-2 is associated with the protocol processing unit 104-2 and the received data storage unit 106-2. Therefore, both the protocol processing unit 104-2 and the received data storage 106-2 are associated with one CAN ID, which is CAN ID 3. In addition, the access controller 108 is set to permit the virtual machine 20-2 to access the received data storage unit 106-2.

In a case where the CAN ID indicated in the header of the received message 10 is CAN_ID_1 or CAN_ID_2, the protocol processing unit 104-1 stores the payload of the received message 10 in the received data storage unit 106-1. On the other hand, the protocol processing unit 104-2 does not store the payload of the received message 10 in the received data storage unit 106-2.

The virtual machine 20-1 can access the received data storage unit 106-1 corresponding to the virtual machine itself. Therefore, both the application 22-1 and the application 22-2 operating on the virtual machine 20-1 can acquire the payload of the received message 10-1 whose destinations are the applications themselves from the received data storage unit 106-1.

In a case where the CAN ID indicated in the header of the received message 10 is CAN_ID_3, the protocol processing unit 104-1 does not store the payload of the received message 10 in the received data storage unit 106-1. On the other hand, the protocol processing unit 104-2 stores the payload of the received message 10 in the received data storage unit 106-2.

The virtual machine 20-2 can access the received data storage unit 106-2 corresponding to the virtual machine itself. Therefore, the application 22-3 operating on the virtual machine 20-2 can acquire the payload of the received message 10-3 whose destination is the application itself from the received data storage unit 106-2.

Note that, in two or more virtual machines 20, applications allocated to the same CAN ID may operate. In this case, one received message 10 is stored in two or more received data storage units 106. Therefore, one received message 10 is used by the plurality of virtual machines 20.

For example, in the example in FIG. 4, it is assumed that the application 22 to which the CAN ID, which is CAN_ID_1, is allocated is operating in the virtual machine 20-2 as well. In this case, the received message 10 whose CAN ID is CAN_ID_1 is stored not only in the received data storage unit 106-1 by the protocol processing unit 104-1, but also in the received data storage unit 106-2 by the protocol processing unit 104-2.

### <Notification of Error>

The protocol processing unit 104 may provide various error notifications as well as the received message 10 to the virtual machine 20. The error notification is, for example, a notification of an acknowledgement error (Ack error) indicating that there is no node that correctly receives a transmitted message on the CAN bus 300. In addition, for example, the error notification is a notification of a bit error indicating that the data transmitted by the protocol processing unit itself is different from the data monitored in the CAN bus 300.

The protocol processing unit 104 stores the error notification to be provided to the virtual machine 20 in the error notification storage area 106E of the received data storage unit 106 corresponding to the protocol processing unit 104. The virtual machine 20 can acquire the error notification transmitted from the protocol processing unit 104 by reading the error notification stored in the error notification storage area 106E of the received data storage unit 106 corresponding to the virtual machine itself. Note that the method of recognizing that the error notification is stored in the error notification storage area 106E of the received data storage unit 106 is similar to the method of recognizing that the payload of the received message 10 is stored in the received data storage unit 106.

In this manner, according to the present embodiment, when confirming the error notification, the virtual machine 20 is only required to confirm the error notification storage area 106E of the received data storage unit 106 allocated to the virtual machine itself. As a result, the virtual machine 20 can easily grasp the error notification related to processing of the virtual machine itself. That is, the error can be notified directly to the virtual machine 20 that is supposed to require the error notification. In addition, the virtual machine 20 does not need to perform processing for an error notification related to processing of another virtual machine 20, that is, an error notification not related to processing of the virtual machine itself. In other words, inter-virtual machine communication for error notification is unnecessary. Therefore, it is possible to heighten software control usability related to communication processing of the virtual machine 20.

### <Transmission of Message by Communication Device 100>

The communication device 100 may transmit a message to the external communication device 200. A message transmitted from the communication device 100 is called a transmitted message.

FIG. 5 is a diagram illustrating a configuration related to transmission of a transmitted message in the configuration of the communication device 100. In FIG. 5, the common reception unit 102 and the received data storage unit 106 are omitted.

The communication control unit 101 includes a plurality of transmitted data storage units 114. The plurality of virtual machines 20 are configured to be able to access different transmitted data storage units 114, respectively. Hereinbelow, the transmitted data storage unit 114 accessible by the virtual machine 20 is also referred to as a “transmitted data storage unit 114 corresponding to the virtual machine 20”.

The transmitted data storage unit 114 is a storage area provided in a freely-selected type of storage device (for example, a RAM, a register, or the like). For example, the plurality of transmitted data storage units 114 include different partial storage areas included in one storage device (for example, one RAM or register), respectively. Alternatively, for example, the plurality of transmitted data storage units 114 may be storage areas included in different storage devices (for example, different RAMs and registers), respectively.

The access controller 108 controls access from the virtual machine 20 to the transmitted data storage units 114. Specifically, in a case where the transmitted data storage unit 114 to be accessed by the virtual machine 20 is the transmitted data storage unit 114 corresponding to the virtual machine 20, the access controller 108 permits the virtual machine 20 to access the transmitted data storage unit 114. On the other hand, in a case where the transmitted data storage unit 114 to be accessed by the virtual machine 20 is not the transmitted data storage unit 114 corresponding to the virtual machine 20, the access controller 108 does not permit the virtual machine 20 to access the transmitted data storage unit 114. Note that the correspondence relationship between the virtual machines 20 and the transmitted data storage units 114 is stored in advance in a storage area accessible from the access controller 108, for example.

A transmitted message 30 includes a payload generated by the virtual machine 20. For example, an application operating on the virtual machine 20 stores a pair including a CAN ID and a payload allocated to the application in the transmitted data storage unit 114. Note that, in a case where the CAN ID is allocated to the virtual machine 20, the application stores the CAN ID corresponding to the virtual machine 20 in the transmitted data storage unit 114.

The transmitted data storage unit 114 corresponding to the virtual machine 20 is associated with the protocol processing unit 104 corresponding to the virtual machine 20. For this reason, the plurality of protocol processing units 104 are associated with different transmitted data storage units 114, respectively.

The protocol processing unit 104 generates the transmitted message 30 by using the pair including the CAN ID and the payload stored in the transmitted data storage unit 114 corresponding to the protocol processing unit itself. Further, the protocol processing unit 104 outputs the generated transmitted message 30 to a common transmission unit 110 provided in the communication device 100. The common transmission unit 110 is an interface for outputting a signal from the communication device 100 to the outside of the communication device 100. A signal representing the transmitted message 30 is output from the common transmission unit 110 to the CAN bus 300. Note that the common transmission unit 110 and the CAN bus 300 are connected via a suitable interface such as a CAN transceiver as necessary.

Here, the communication device 100 is configured such that an output from each of the plurality of protocol processing units 104 toward the common transmission unit 110 is input into the common transmission unit 110 via an AND gate 112. An output from the AND gate 112 represents a logical AND of a plurality of input bits. Therefore, the output from the AND gate 112 is a logical AND signal of the signals output from the respective protocol processing units 104. The logical AND signal is input into the common transmission unit 110. The common transmission unit 110 outputs the logical AND signal output from the AND gate 112 to the CAN bus 300.

Here, in the CAN protocol, 0 is a dominant bit, and 0 is prioritized over 1. By using the AND gate 112, 0 can be prioritized over 1 in the signals input from the plurality of protocol processing units 104 to the common transmission unit 110.

Therefore, by employing the configuration in which the logical AND signal of the outputs from the plurality of protocol processing units 104 is input into the common transmission unit 110, it is possible to cause the plurality of protocol processing units 104 to share one transmission interface in accordance with the CAN protocol. That is, the transmission of the CAN message to the CAN bus by the plurality of protocol processing units 104 can be handled by one transmission interface.

Note that the protocol processing unit 104 recognizes that data is stored in the transmitted data storage unit 114 corresponding to the protocol processing unit itself by an appropriate method. As a method of recognizing that data is stored in the transmitted data storage unit 114, a similar method to the method of recognizing that data is stored in the received data storage unit 106 can be employed.

### <Procedure of Processing>

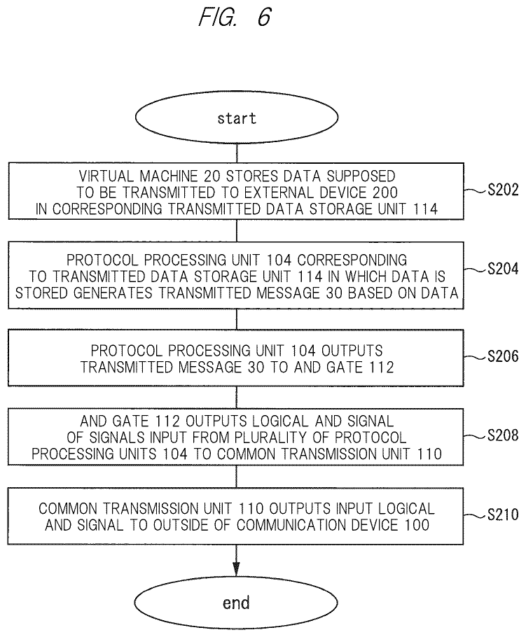

FIG. 6 is a flowchart illustrating a procedure of message transmission in the communication device 100. The virtual machine 20 stores data supposed to be transmitted to the external communication device 200 in the transmitted data storage unit 114 corresponding to the virtual machine 20 itself (S202). The protocol processing unit 104 corresponding to the transmitted data storage unit 114 in which data is stored by the virtual machine 20 generates the transmitted message 30 based on the data (S204). The protocol processing unit 104 outputs the generated transmitted message 30 to the AND gate 112 (S206). The AND gate 112 outputs a logical AND signal of the signals input from the plurality of protocol processing units 104 to the common transmission unit 110 (S208). The common transmission unit 110 outputs the logical AND signal input from the AND gate 112 to the outside of the communication device 100 (S210).

### <Handling of Collision>

Here, the outputs from the plurality of protocol processing units 104 are collected at the AND gate 112. Therefore, in a case where the transmitted messages 30 are simultaneously output by the plurality of protocol processing units 104, a collision occurs inside the communication device 100. Each protocol processing unit 104 handles the collision by performing collision detection and arbitration in accordance with the CAN protocol.

Specifically, the protocol processing unit 104 performs collision detection in accordance with the CAN protocol on the signal input from the common reception unit 102 to the protocol processing unit 104. Here, the signal output from the common transmission unit 110 to the CAN bus 300 is input into each protocol processing unit 104 since the signal flowing through the CAN bus 300 is input into the common reception unit 102. Therefore, by performing collision detection in accordance with the CAN protocol in each protocol processing unit 104, it is possible to detect collision of the transmitted messages 30 transmitted from the plurality of protocol processing units 104. Also, by performing arbitration in accordance with the CAN protocol in each protocol processing unit 104, it is possible to perform arbitration among the plurality of protocol processing units 104.

<Sharing of Transmission State between Protocol Processing Units 104>

In CAN communication, when correctly receiving a message, a node connected to the CAN bus 300 returns an acknowledgement (Ack). This allows the transmission source node to confirm that the message has been received by another node. Furthermore, the transmission source node can perform operations such as retransmission of a message in a case where the Ack is not returned from the other node, that is, in a case of an Ack error. However, since the Ack does not include the transmission source information, the transmission source node cannot recognize which node has returned the Ack.

Here, in the communication device 100 having the configuration illustrated in FIG. 5, one of the plurality of virtual machines 20 is referred to as a virtual machine 20-1, and another one is referred to as a virtual machine 20-2. In addition, one of the plurality of protocol processing units 104 is referred to as a protocol processing unit 104-1 corresponding to the virtual machine 20-1, and another one is referred to as a protocol processing unit 104-2 corresponding to the virtual machine 20-2. It is assumed that a transmitted message created by the corresponding protocol processing unit 104-1 based on an instruction from the virtual machine 20-1 is output to the external communication device 200 connected to the CAN bus 300. When correctly receiving the transmitted message on the CAN bus 300, the external communication device 200 returns an Ack. On the other hand, in the communication device 100, the protocol processing unit 104-2 corresponding to the virtual machine 20-2 can also receive the message on the CAN bus 300 via the common reception unit 102. The protocol processing unit 104-2 transmits an Ack when correctly receiving the message. Therefore, the protocol processing unit 104-2 provided in the communication device 100 can return the Ack in response to the message transmitted by the protocol processing unit 104-1 in the same communication device 100.

If the Ack in response to the transmitted message 30 output from a certain protocol processing unit 104 is returned from another protocol processing unit 104 in the same communication device 100, even in a case where the destination external communication device 200 fails to receive the transmitted message 30 for some reason and does not return the Ack, the protocol processing unit 104 as transmission source recognizes that the transmitted message is correctly received. Therefore, it is difficult for the transmission source protocol processing unit 104 to confirm whether the transmitted message 30 has been received by the destination external communication device 200.

Therefore, the communication device 100 is preferably configured such that another protocol processing unit 104 does not return an Ack in response to the transmitted message 30 output from a certain protocol processing unit 104. To achieve this, for example, each protocol processing unit 104 is configured to be able to detect a state in which the transmitted message 30 is being output by another protocol processing unit 104.

For example, each protocol processing unit 104 is configured to output a status signal indicating whether or not the transmitted message 30 is being transmitted. When receiving the CAN message, each protocol processing unit 104 checks the status signal to determine whether or not another protocol processing unit 104 is in a state of being transmitting a message. Then, in a case where the status signal indicates that any of the protocol processing units 104 is in a state of being transmitting a message, the protocol processing unit 104 does not return an Ack. On the other hand, in a case where the status signal indicates that none of the protocol processing units 104 is in a state of being transmitting a message, the protocol processing unit 104 returns an Ack.

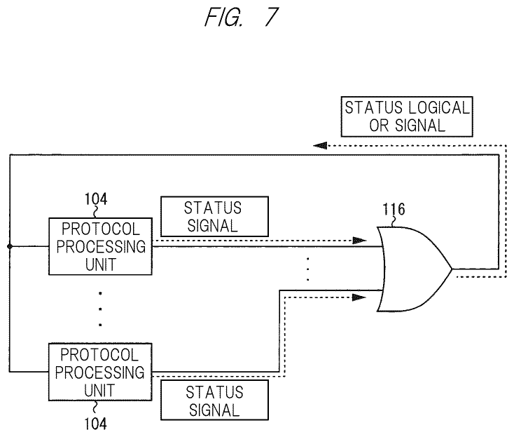

FIG. 7 is a diagram illustrating a configuration in which a status signal is output from each protocol processing unit 104. In FIG. 7, the status signal output from each protocol processing unit 104 is input into an OR gate 116. A signal representing a logical OR of the status signals input from the respective protocol processing units 104 (hereinbelow, the signal is referred to as a status logical OR signal) is output from the OR gate 116. The status logical OR signal is input into each protocol processing unit 104.

Here, if any one of the status signals output from the plurality of protocol processing units 104 indicates 1, the status logical OR signal is 1. Therefore, the status logical OR signal being 1 indicates that at least one protocol processing unit 104 is in a state of being transmitting a message.

Each protocol processing unit 104 is configured to return an Ack in a case where the status logical OR signal that indicates 0 is input. In addition, each protocol processing unit 104 is configured not to return an Ack in a case where the status logical OR signal that indicates 1 is input.

More specifically, for example, each protocol processing unit 104 is configured to overwrite an Ack slot of a CAN message output from the protocol processing unit 104 with a recessive state while the status logical OR signal indicates 1. The Ack slot is a slot that is set to be in a dominant state only when the Ack is returned. Therefore, overwriting the Ack slot with the recessive state means that the Ack is not returned.

### <Protocol Processing Unit 104 Not Sharing Reception Unit>

The common reception unit 102 is not necessarily shared by all the protocol processing units 104 provided in the communication device 100. In other words, in the communication device 100, there may be a protocol processing unit 104 that does not use the common reception unit 102.

For example, the communication device 100 includes not only the common reception unit 102 but also a reception unit (hereinbelow, an individual reception unit) individually for each protocol processing unit 104. Then, the communication device 100 is configured to be able to set, for each protocol processing unit 104, from which of the common reception unit 102 and the individual reception unit an output is input.

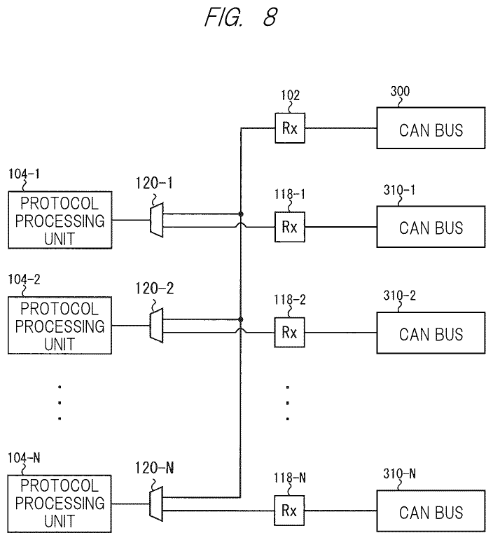

FIG. 8 is a diagram illustrating a configuration in which an individual reception unit is provided for each protocol processing unit 104. In this example, an individual reception unit 118 and a selector 120 are provided for each protocol processing unit 104. Specifically, individual reception units 118-1 to 118-N are provided corresponding to protocol processing units 104-1 104-N, respectively. Furthermore, selectors 120-1 to 120-N are provided corresponding to the protocol processing units 104-1 to 104-N, respectively. Note that, in the following description, the individual reception unit 118 is used as any one of the individual reception units 118-1 to 118-N for convenience. The selector 120 is used to as any one of the selectors 120-1 to 120-N for convenience.

The individual reception unit 118 is an interface into which a CAN message is input from a CAN bus 310, which is different from the CAN bus 300. The individual reception units 118 are connected to different CAN buses 310, respectively. Specifically, the individual reception units 118-1 to 118-N are connected to the corresponding CAN buses 310-1 to 310-N, respectively. Each individual reception unit 118 and each CAN bus 310 are connected via a suitable interface such as a CAN transceiver as necessary.

Both the common reception unit 102 and the individual reception unit 118 are connected to the input interface of the selector 120. The protocol processing unit 104 corresponding to the selector 120 is connected to the output interface of the selector 120. The selector 120 can be set to output only either the signal input from the common reception unit 102 or the signal input from the individual reception unit 118.

It is assumed that the selector 120 corresponding to the protocol processing unit 104 is set to output the signal input from the common reception unit 102. In this case, the protocol processing unit 104 shares a reception unit with another protocol processing unit 104 and is connected to the CAN bus 300. On the other hand, it is assumed that the selector 120 corresponding to the protocol processing unit 104 is set to output the signal input from the individual reception unit 118. In this case, the protocol processing unit 104 does not share a reception unit with another protocol processing unit 104 and is connected to the corresponding CAN bus 310.

Note that, in FIG. 8, in order to facilitate the description of the individual reception unit 118, all the individual reception units 118 are connected to the CAN buses 310. However, in actual operation, the individual reception unit 118 may be connected to the CAN bus 310 only in a case where the individual reception unit 118 is used. That is, in a case where a certain selector 120 is set to output a signal input from the common reception unit 102, the individual reception unit 118 corresponding to the selector 120 does not need to be connected to the CAN bus 310.

By employing the configuration illustrated in FIG. 8, it is possible to easily set whether or not each protocol processing unit 104 shares a reception unit with another protocol processing unit 104. In other words, it is possible to easily set whether each protocol processing unit 104 is to participate in the same CAN network as that for another protocol processing unit 104 or to participate in a different CAN network from that for another protocol processing unit 104.

### <Protocol Processing Unit 104 Not Sharing Transmission Unit>

The common transmission unit 110 is not necessarily shared by all the protocol processing units 104 provided in the communication device 100. In other words, in the communication device 100, there may be a protocol processing unit 104 that does not use the common transmission unit 110.

For example, the communication device 100 includes not only the common transmission unit 110 but also a transmission unit (hereinbelow, an individual transmission unit) individually for each protocol processing unit 104. Then, the communication device 100 is configured to be able to set to which of the common transmission unit 110 and the individual reception unit the output from each protocol processing unit 104 is input.

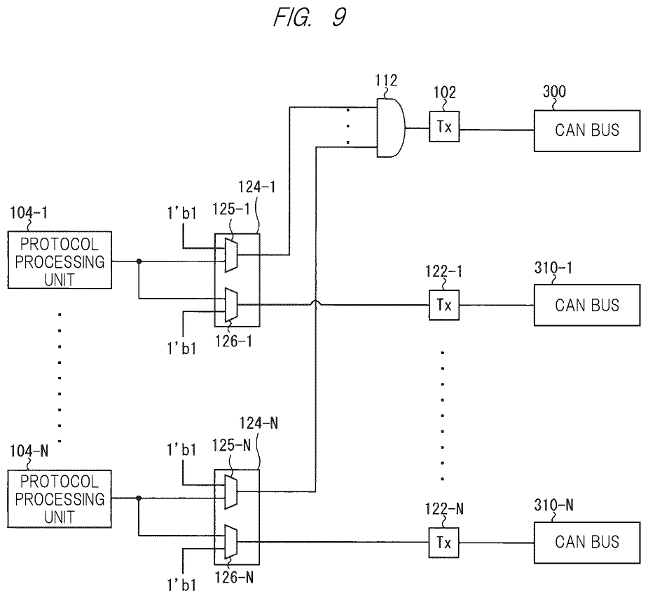

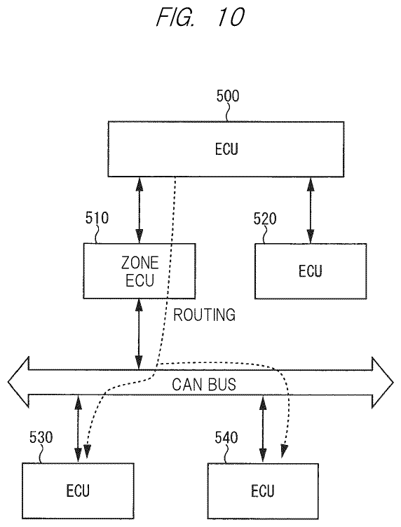

FIG. 9 is a diagram illustrating a configuration in which an individual transmission unit is provided for each protocol processing unit 104. In the example in FIG. 9, an individual transmission unit 122 and a selector 124 are provided for each protocol processing unit 104. Specifically, individual transmission units 122-1 to 122-N are provided corresponding to the protocol processing units 104-1 to 104-N, respectively. Furthermore, selectors 124-1 to 124-N are provided corresponding to the protocol processing units 104-1 to 104-N, respectively. Note that, in the following description, the individual transmission unit 122 is referred to as any one of the individual transmission units 122-1 to 122-N for convenience. The selector 124 is referred to as any one of the selectors 124-1 to 124-N for convenience.

Each individual transmission unit 122 is an interface for outputting a signal to not the CAN bus 300 but the CAN bus 310. Note that the individual transmission units 122 are connected to different CAN buses 310, respectively. Specifically, the individual transmission units 122-1 to 122-N are connected to the CAN buses 310-1 to 310-N, respectively. Each individual transmission unit 122 and each CAN bus 310 are connected via a suitable interface such as a CAN transceiver as necessary.

The selector 124 is configured to output the transmitted message 30 input from the protocol processing unit 104 to either the common transmission unit 110 or the individual transmission unit 122. For this purpose, the selector 124 includes a first selector 125 and a second selector 126.

The first selector 125 is a selector used to transmit the output from the protocol processing unit 104 to the common transmission unit 110. On the other hand, the second selector 126 is a selector used to transmit the output from the protocol processing unit 104 to the individual transmission unit 122.

A signal output from the protocol processing unit 104 and a signal always representing 1 (in other words, the signal is a signal always representing a recessive state) are input into the input interface of the first selector 125. The AND gate 112 is connected to the output interface of the first selector 125.

A signal output from the protocol processing unit 104 and a signal always representing 1 (in other words, the signal is a signal always representing a recessive state) are input into the input interface of the second selector 126. The individual transmission unit 122 is connected to the output interface of the second selector 126.

In a case where the protocol processing unit 104 is caused to use the common transmission unit 110, the first selector 125 is set to output a signal input from the protocol processing unit 104, while the second selector 126 is set to output a signal always representing 1. In a case where the protocol processing unit 104 is caused to use the individual transmission unit 122, the first selector 125 is set to output a signal always representing 1, while the second selector 126 is set to output a signal input from the protocol processing unit 104.

Note that, in FIG. 9, in order to facilitate the description of the individual transmission unit 122, all the individual transmission units 122 are connected to the CAN buses 310. However, in an actual operation, in a case where a certain protocol processing unit 104 is caused to use the common transmission unit 110, the individual transmission unit 122 corresponding to the protocol processing unit 104 does not need to be connected to the CAN bus 310.

By employing the configuration illustrated in FIG. 9, it is possible to easily set whether or not each protocol processing unit 104 shares a transmission unit with another protocol processing unit 104. In other words, it is possible to easily set whether each protocol processing unit 104 is to participate in the same CAN network as that for another protocol processing unit 104 or to participate in a different CAN network from that for another protocol processing unit 104.

### Usage Example of Communication Device 100

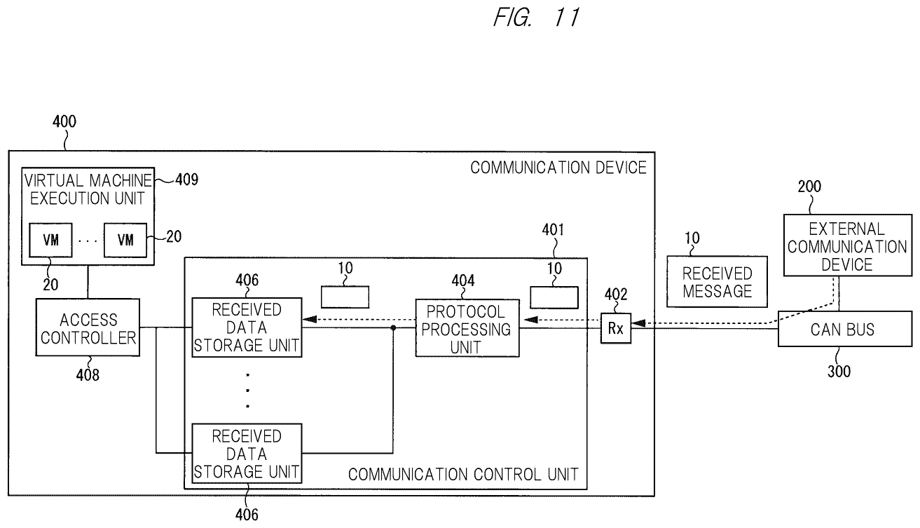

For example, the communication device 100 is suitable for an ECU that achieves a plurality of virtual ECUs (ECUs achieved by virtual machines) such as a zone ECU. FIG. 10 is a diagram illustrating a hierarchical structure of a system having a zone ECU. The zone ECU has a routing function of transferring data received from a superordinate system to a subordinate ECU. For example, in FIG. 10, a zone ECU 510 executes routing for transferring data received from a superordinate ECU 500 to a subordinate ECU 530 or ECU 540 via the CAN bus.

In a case where a plurality of virtual machines are operated in one physical ECU, each of the virtual machines can be treated as a virtual ECU. Therefore, for example, in the communication device 100, one of the plurality of virtual machines 20 is used as a virtual ECU for routing.

Here, the protocol processing unit 104 corresponding to the virtual ECU for routing is preferably set to use the individual reception unit 118 and the individual transmission unit 122. With this setting, it is possible to reduce the influence of the routing of the CAN message by the virtual ECU for routing on the transmission and reception of the CAN message performed by another virtual ECU.

Note that, in a case where the virtual machine execution unit 109 includes a plurality of processors, it is preferable to allocate a dedicated processor to the virtual ECU for routing.

By allocating a dedicated processor to the virtual ECU for routing, the influence of the routing processing on the processing of another virtual ECU can further be reduced.

### Second Embodiment

FIG. 11 is a diagram illustrating a configuration of a communication device according to a second embodiment. Similarly to the communication device 100, a communication device 400 transmits and receives a CAN message to and from the external communication device 200 connected to the CAN bus 300 in accordance with the CAN protocol. Similarly to the communication device 100, the communication device 400 is, for example, an integrated circuit provided inside an ECU or the like, and more specifically, is an SoC such as an MCU.

On the other hand, unlike in the communication device 100, in the communication device 400, reception of the CAN message for a plurality of virtual machines is controlled by means of a communication control unit 401 including one protocol processing unit. For this purpose, the communication device 400 includes a reception unit 402, the communication control unit 401, and an access controller 408. The communication control unit 401 includes a protocol processing unit 404 and a plurality of received data storage units 406.

The reception unit 402 is an interface that receives a message on the CAN bus 300. The reception unit 402 is configured to output a message received by the reception unit 402, that is, the received message 10, to the protocol processing unit 404. Note that the reception unit 402 is connected to the CAN bus 300 via a suitable interface such as a CAN transceiver as necessary.

Similarly to the received data storage area 106D of the received data storage unit 106, the received data storage unit 406 is a storage area provided in a freely-selected type of storage device.

Similarly to the virtual machine execution unit 109, the virtual machine execution unit 409 operates the plurality of virtual machines 20. The plurality of virtual machines 20 are associated with different received data storage units 406, respectively.

Similarly to the access controller 108, the access controller 408 controls access to the received data storage units 406 from the virtual machines 20. That is, in a case where the received data storage unit 406 to be accessed by the virtual machine 20 is the received data storage unit 406 corresponding to the virtual machine 20, the access controller 408 permits the virtual machine 20 to access the received data storage unit 406. On the other hand, in a case where the received data storage unit 406 to be accessed by the virtual machine 20 is not the received data storage unit 406 corresponding to the virtual machine 20, the access controller 408 does not permit the virtual machine 20 to access the received data storage unit 406. Note that the correspondence relationship between the virtual machine 20 and the received data storage unit 406 is stored in advance in a freely-selected storage area accessible from the access controller 408, for example.

The protocol processing unit 404 extracts a payload and a CAN ID from the received message 10 in accordance with the CAN protocol. In which received data storage unit 406 the extracted payload is to be stored is determined by a reception filter, which is not illustrated in FIG. 11. In other words, it is determined in which virtual machine 20 the received message 10 is to be used (which virtual machine 20 is the destination of the received message). The extracted payload is stored in the received data storage unit 406 corresponding to the virtual machine 20 that is to use the payload based on the determination result.

As a result of the above processing, the payload of the received message 10 is stored in one received data storage unit 406. The received data storage unit 406 in which the payload of the received message 10 is stored is the received data storage unit 406 accessible from the virtual machine 20 that is the destination of the received message 10. Therefore, the payload of the received message 10 is stored in the received data storage unit 406 so as to be accessed only from the virtual machine 20 that is the destination of the received message 10. Note that, similarly to the case of the first embodiment, the received data storage unit 406 can store the CAN ID and the like as well as the payload of the received message 10.

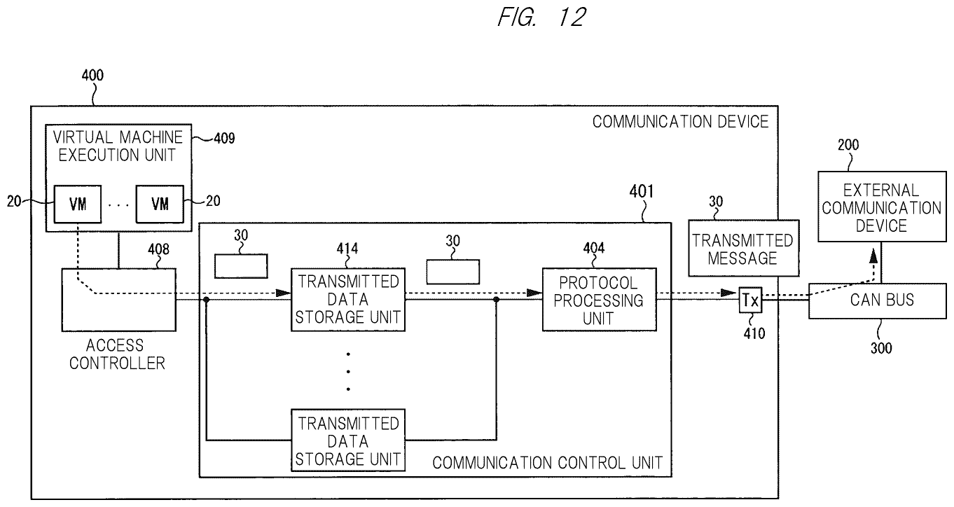

Further, the communication device 400 controls transmission of the CAN message by a plurality of virtual machines by means of one protocol processing unit 404. FIG. 12 is a diagram illustrating a configuration of the communication device 400 related to transmission of the transmitted message 30. In FIG. 12, the reception unit 402 and the received data storage unit 406 are omitted.

The communication control unit 401 includes a transmission unit 410 and a plurality of transmitted data storage units 414. Similarly to the transmitted data storage unit 114, the transmitted data storage unit 414 is a storage area provided in a freely-selected type of storage device. The plurality of virtual machines 20 is configured to be able to access different transmitted data storage units 414, respectively. Hereinbelow, the transmitted data storage unit 414 accessible by the virtual machine 20 is also referred to as a “transmitted data storage unit 414 corresponding to the virtual machine 20”.

The access controller 408 controls access from the virtual machine 20 to the transmitted data storage unit 414 by a similar method to a method in which the access controller 108 controls access from the virtual machine 20 to the transmitted data storage unit 114. Specifically, in a case where the transmitted data storage unit 414 to be accessed by the virtual machine 20 is the transmitted data storage unit 414 corresponding to the virtual machine 20, the access controller 408 permits the virtual machine 20 to access the transmitted data storage unit 414. On the other hand, in a case where the transmitted data storage unit 414 to be accessed by the virtual machine 20 is not the transmitted data storage unit 414 corresponding to the virtual machine 20, the access controller 408 does not permit the virtual machine 20 to access the transmitted data storage unit 414. Note that the correspondence relationship between the virtual machine 20 and the transmitted data storage unit 414 is stored in advance in a freely-selected storage area accessible from the access controller 408, for example.

The virtual machine 20 of the second embodiment stores data (such as a payload and a CAN ID) to be transmitted to the external communication device 200 in the transmitted data storage unit 414. In a case where data is stored in any one of the transmitted data storage units 414, the protocol processing unit 404 generates the transmitted message 30 using the data. Further, the protocol processing unit 404 outputs the generated transmitted message 30 to the transmission unit 410. The transmission unit 410 outputs the transmitted message 30 input from the protocol processing unit 404 to the CAN bus 300.

### Example of Operation and Effect

With the above-described configuration, according to the communication device 400, unlike the technology disclosed in Patent Document 1, only the virtual machine 20 as the destination of the received message 10 can use the payload of the received message 10. Therefore, each virtual machine 20 only needs to grasp whether data is stored in the received data storage unit 406 allocated to the virtual machine itself. Also, each virtual machine 20 does not need to notify another virtual machine that a new message has been stored. That is, it is possible to heighten software usability related to processing in a plurality of virtual machines.

In addition, according to the communication device 400, since one protocol processing unit 404 can handle the plurality of virtual machines 20, the number of protocol processing units 404 provided in the communication device 400 can be reduced. This brings about an advantage that the manufacturing cost of the communication device 400 can be reduced and an advantage that the size of the communication device 400 can be reduced.

### Example of Hardware Configuration

The hardware configuration of the communication device 400 is similar to the hardware configuration of the communication device 100. That is, the hardware configuration of the virtual machine execution unit 409 is represented by, for example, FIG. 2.

### <Procedure of Reception>

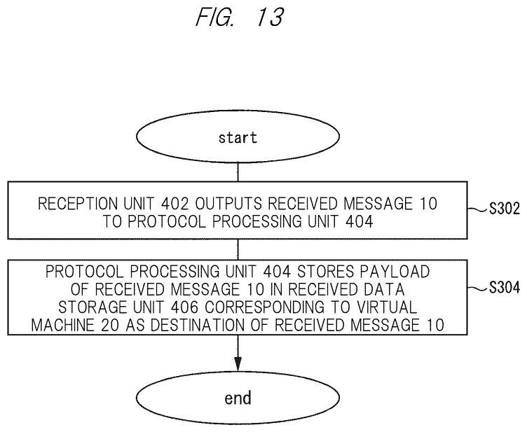

FIG. 13 is a flowchart illustrating a procedure of message reception in the communication device 400. The reception unit 402 outputs the received message 10 input from the CAN bus 300 to the protocol processing unit 404 (S302). The protocol processing unit 404 stores the payload of the received message 10 in the received data storage unit 406 corresponding to the virtual machine 20 as the destination of the received message 10 (S304).

### <Procedure of Transmission>

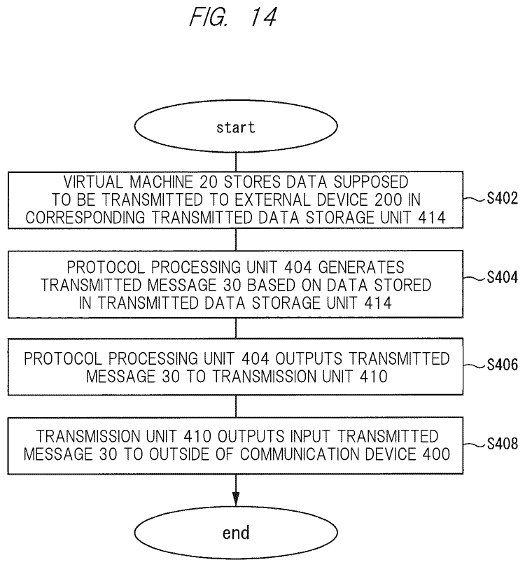

FIG. 14 is a flowchart illustrating a procedure of message transmission in the communication device 400. The virtual machine 20 stores data supposed to be transmitted to the external communication device 200 in the transmitted data storage unit 414 corresponding to the virtual machine 20 (S402). The protocol processing unit 404 generates the transmitted message 30 based on the data stored in the transmitted data storage unit 414 (S404). The protocol processing unit 404 outputs the generated transmitted message 30 to the transmission unit 410 (S406). The transmission unit 410 outputs the transmitted message 30 to the outside of the communication device 400 (S408).

Although the invention made by the present inventor has been specifically described based on the embodiments, the present invention is not limited to the above embodiments, and it goes without saying that various modifications can be made without departing from the gist of the present invention.

Note that the CAN also includes a standard called CAN with Flexible Data Rate (CAN FD) and a standard called CAN eXtra Large payload (CAN XL). In the above example, the message may be a message in accordance with the CAN standard, the CAN FD standard, or the CAN XL standard.

Note that, in the above-described example, the program includes a command group (or software code) for causing the computer to perform one or more functions described in the embodiment when being read by the computer. The program may be stored in a non-transitory computer-readable medium or a tangible storage medium. By way of example and without limitation, the computer-readable medium or the tangible storage medium includes a RAM, a ROM, a flash memory, an SSD, or another memory technology, a CD-ROM, a digital versatile disc (DVD), a Blu-ray (registered trademark) disc, or another optical disc storage, a magnetic cassette, a magnetic tape, a magnetic disc storage, or another magnetic storage device. The program may be transmitted on a transitory computer-readable medium or a communication medium. By way of example and without limitation, the transitory computer-readable medium or the communication medium includes an electric, optical, acoustic, or another form of propagated signal.

What is claimed is:

1. A communication device comprising:
a virtual machine execution unit that includes at least one processor and a storage device and is configured to operate a plurality of virtual machines;
a first reception unit that receives a message transmitted from an outside of the communication device;
a communication control unit that includes a plurality of received data storage units allocated to the plurality of virtual machines, respectively, and stores a received message that is a message received by the first reception unit in the received data storage unit allocated to the virtual machine that is to use the received message; and
an access controller that is configured to allow each of the plurality of virtual machines to access the received data storage unit associated to the virtual machine.

2. The communication device according to claim 1,
wherein the received message is a Controller Area Network (CAN), CAN with Flexible Data Rate (CAN FD), or CAN eXtra Large payload (CAN XL) message.

3. The communication device according to claim 2,
wherein the communication control unit includes a plurality of protocol processing units corresponding to the different virtual machines, respectively,
wherein the first reception unit outputs the received message to each of the plurality of protocol processing units, and
wherein, in a case where a destination of the received message is the virtual machine corresponding to the protocol processing unit, the protocol processing unit stores data included in the received message in the received data storage unit corresponding to the protocol processing unit.

4. The communication device according to claim 3,
wherein a different CAN identifier is allocated to each of the virtual machines,
wherein the protocol processing unit is associated with a CAN identifier allocated to the virtual machine corresponding to the protocol processing unit,
wherein the received data storage unit is associated with a CAN identifier allocated to the virtual machine corresponding to the received data storage unit, and
wherein, in a case where a CAN identifier indicated in the received message is the CAN identifier corresponding to the protocol processing unit, the protocol processing unit stores data included in the received message in the received data storage unit corresponding to the CAN identifier.

5. The communication device according to claim 3,
wherein one or more applications are operating on each of the virtual machines,
wherein a different CAN identifier is allocated to each of the applications,
wherein the protocol processing unit is associated with a CAN identifier allocated to each of the one or more applications operating on the virtual machine corresponding to the protocol processing unit,
wherein the received data storage unit is associated with a CAN identifier allocated to each of the one or more applications operating on the virtual machine corresponding to the received data storage unit, and
wherein, in a case where a CAN identifier indicated in the received message is the CAN identifier corresponding to the protocol processing unit, the protocol processing unit stores data included in the received message in the received data storage unit corresponding to the CAN identifier.

6. The communication device according to claim 3,
wherein each of the protocol processing units includes a second reception unit that receives the received message from the outside of the communication device and outputs the received message to the protocol processing unit, and
wherein each of the protocol processing units includes a selector that outputs either a signal input from the first reception unit or a signal input from the second reception unit to the protocol processing unit.

7. The communication device according to claim 3, comprising:
a plurality of transmitted data storage units that correspond to the different virtual machines;
an AND gate that outputs a logical AND signal representing a logical AND of a plurality of signals input from the plurality of protocol processing units; and
a first transmission unit that outputs the logical AND signal input from the AND gate to the outside of the communication device,
wherein the access controller permits the virtual machine to access the transmitted data storage unit corresponding to the virtual machine,
wherein the virtual machine stores data to be transmitted to the outside of the communication device in the transmitted data storage unit, and
wherein the protocol processing unit generates a transmitted message that is a message to be transmitted to the outside of the communication device based on the data stored in the transmitted data storage unit by the virtual machine corresponding to the protocol processing unit, and outputs the transmitted message to the AND gate.

8. The communication device according to claim 7,
wherein each of the protocol processing units outputs a status signal indicating whether or not the transmitted message is in a state of being output,
wherein an OR gate is provided that outputs a logical OR signal representing a logical OR of the status signals input from the protocol processing units, to each of the protocol processing units, and
wherein each of the protocol processing units does not return an acknowledgment in a case where the logical OR signal indicates that the transmitted message is in a state of being transmitted by at least one of the protocol processing units.

9. The communication device according to claim 7,
wherein each of the protocol processing units includes a second transmission unit that outputs the transmitted message output from the protocol processing unit to the outside of the communication device, and
wherein each of the protocol processing units includes a selector that outputs the transmitted message input from the protocol processing unit to either the first transmission unit or the second transmission unit.

10. The communication device according to claim 3, further comprising a plurality of error notification storage units allocated to the plurality of virtual machines, respectively.

11. A communication method executed by a communication device, the communication device including
a virtual machine execution unit that includes at least one processor and a storage device and is configured to operate a plurality of virtual machines,
a first reception unit that receives a message transmitted from an outside of the communication device,
a communication control unit that includes a plurality of received data storage units allocated to the plurality of virtual machines, respectively, and
an access controller that is configured to allow each of the plurality of virtual machines to access the received data storage unit associated to the virtual machine,
the communication method comprising:
outputting, by the first reception unit, a received message, which is the message received, to the communication control unit; and
storing, by the communication control unit, the received message in the received data storage unit allocated to the virtual machine that is to use the received message.

12. The communication method according to claim 11,
wherein the received message is a Controller Area Network (CAN), CAN with Flexible Data Rate (CAN FD), or CAN eXtra Large payload (CAN XL) message.

13. The communication method according to claim 12,
wherein the communication control unit includes a plurality of protocol processing units corresponding to the different virtual machines, respectively,
the communication method comprising:
outputting, by the first reception unit, the received message to each of the plurality of protocol processing units; and
in a case where a destination of the received message is the virtual machine corresponding to the protocol processing unit, storing, by the protocol processing unit, data included in the received message in the received data storage unit corresponding to the protocol processing unit.

14. The communication method according to claim 13,
wherein a different CAN identifier is allocated to each of the virtual machines,
wherein the protocol processing unit is associated with a CAN identifier allocated to the virtual machine corresponding to the protocol processing unit, and
wherein the received data storage unit is associated with a CAN identifier allocated to the virtual machine corresponding to the received data storage unit,
the communication method comprising, in a case where a CAN identifier indicated in the received message is the CAN identifier corresponding to the protocol processing unit, storing, by the protocol processing unit, data included in the received message in the received data storage unit corresponding to the CAN identifier.

15. The communication method according to claim 13,
wherein one or more applications are operating on each of the virtual machines,
wherein a different CAN identifier is allocated to each of the applications,
wherein the protocol processing unit is associated with a CAN identifier allocated to each of the one or more applications operating on the virtual machine corresponding to the protocol processing unit, and
wherein the received data storage unit is associated with a CAN identifier allocated to each of the one or more applications operating on the virtual machine corresponding to the received data storage unit,
the communication method comprising, in a case where a CAN identifier indicated in the received message is the CAN identifier corresponding to the protocol processing unit, storing, by the protocol processing unit, data included in the received message in the received data storage unit corresponding to the CAN identifier.

16. The communication method according to claim 13,
wherein, in the communication device, each of the protocol processing units includes a second reception unit that receives the received message from the outside of the communication device, and a selector,
the communication method comprising:
outputting, by the second reception unit, the received message to the selector corresponding to the second reception unit; and
outputting, by the selector, either a signal input from the first reception unit or a signal input from the second reception unit to the protocol processing unit corresponding to the selector.

17. The communication method according to claim 13,
wherein the communication device includes a plurality of transmitted data storage units that correspond to the different virtual machines, an AND gate, and a first transmission unit, and
wherein the access controller permits the virtual machine to access the transmitted data storage unit corresponding to the virtual machine,
the communication method comprising:
storing, by the virtual machine, data to be transmitted to the outside of the communication device in the transmitted data storage unit;
generating, by the protocol processing unit, a transmitted message that is a message to be transmitted to the outside of the communication device based on the data stored in the transmitted data storage unit by the virtual machine corresponding to the protocol processing unit, and outputting the transmitted message to the AND gate;
outputting, by the AND gate, a logical AND signal representing a logical AND of a plurality of signals output from the plurality of protocol processing units; and
outputting, by the first transmission unit, the logical AND signal input from the AND gate to the outside of the communication device.

18. The communication method according to claim 17,
wherein the communication device includes an OR gate,
the communication method comprising:
outputting, by each of the protocol processing units, a status signal indicating whether or not the transmitted message is in a state of being output;
outputting, by the OR gate, a logical OR signal representing a logical OR of the status signals input from the protocol processing units, to each of the protocol processing units; and
not returning, by each of the protocol processing units, an acknowledgment in a case where the logical OR signal indicates that the transmitted message is in a state of being transmitted by at least one of the protocol processing units.

19. The communication method according to claim 17,
wherein, in the communication device, each of the protocol processing units includes a second transmission unit that outputs the transmitted message output from the protocol processing unit to the outside of the communication device, and a selector,
the communication method comprising outputting, by the selector, the transmitted message input from the protocol processing unit corresponding to the selector to either the first transmission unit or the second transmission unit.
